(19) United States
(12) Patent Application Publication
(10) Pub. No.: US 2005/0071196 A1
(43) Pub. Date: Mar. 31, 2005

(54) System for facilitating generation of a form

(76) Inventor: Christina A. Del Pin, Greenwich, CT (US)

Correspondence Address: ST. ONGE STEWARD JOHNSTON & REENS, LLC, 986 BEDFORD STREET, STAMFORD, CT, 06905-5619, US

(21) Appl. No.: 10/865,059

(22) Filed: Jun. 10, 2004

Related U.S. Application Data
(60) Provisional application No. 60/506,834, filed on Sep. 29, 2003.

(51) Int. Cl. G06F 17/60

(52) U.S. Cl. 705/2

(57) ABSTRACT

The invention relates to a system for facilitating generation of a form including a computer, software executing on the computer for receiving procedure information indicative of a procedure performed on a patient, software executing on the computer for receiving diagnosis information indicative of a diagnosis of a condition of the patient, software executing on the computer for retrieving a procedure code based upon the received procedure information, software executing on the computer for retrieving a diagnosis code based upon the received diagnosis information, and software executing on the computer for transmitting the procedure code and the diagnosis code for use in generating a claim form.

### PRIOR APPLICATION

Applicant claims the priority benefit under 35 U.S.C. §119(e) of U.S. Provisional Patent Application Ser. No. 60/506,834 filed Sep. 29, 2003.

### FIELD OF THE INVENTION

The invention relates to a system for facilitating the generation of forms and, more particularly, medical claim forms.

### BACKGROUND OF THE INVENTION

Filling out forms, such as claim forms, often involve a user manually inputting information into blanks on the form. For example, with a medical claim form, a user may enter his/her identification, policy number, purpose for seeking medical treatment, cost, physician information, or other information describing the visit. Other forms, such as life insurance applications, vehicle registration forms, license renewal forms, and the like may also involve a user manually inputting information into blanks on the form.

Although the specific information may vary from form to form, the forms typically involve user intervention in order to complete the form by manually inputting information into selected areas of the forms. A user who may need to complete multiple forms could find this task monotonous and time consuming. Should the user be responsible for completing forms as a part of employment, such as an employee of a physician's office or of a motor vehicle office, the user may find the task of completing forms as leading to a generally unsatisfying employment, particularly since numerous forms may be required to be completed on a daily or even hourly basis.

What is desired, therefore, is a system that facilitates the completion of a form. What is also desired is a system that automates or partially automates the completion of a form. A further desire is a system that reduces the amount of data manually inputted by a user.

### SUMMARY OF THE INVENTION

It is therefore an object of the invention to provide a system that automatically retrieves information from a database.

Another object is to provide a system that automatically inserts the automatically retrieved information into particular areas of a form.

Another object is to provide a system that, upon being prompted, automatically retrieves and displays information from a database and, upon being optionally prompted, automatically inserting the information into particular areas of the form.

A further object is to provide a system that automatically searches through a storage medium to match user inputted information with particular codes, guidelines, or rules relevant to the user inputted information.

These and other objects of the invention are provided by a system for facilitating generation of a form including a computer, software executing on the computer for receiving procedure information indicative of a procedure performed on a patient, software executing on the computer for receiving diagnosis information indicative of a diagnosis of a condition of the patient, software executing on the computer for retrieving a procedure code based upon the received procedure information, software executing on the computer for retrieving a diagnosis code based upon the received diagnosis information, and software executing on the computer for transmitting the procedure code and the diagnosis code for use in generating a claim form.

The invention may optionally include software executing on the computer for authenticating a user based on submitted user identification information. The invention may also include software executing on the computer for prompting a user to submit procedure and diagnosis information.

In some aspects, the invention may include software executing on the computer for requesting additional comments to be submitted by a user, software executing on the computer for receiving the requested additional comments, and software executing on the computer for relating the requested additional comments to the procedure code and diagnosis code.

In still further aspects, the invention includes software executing on the computer for listing a list of procedure codes along with a corresponding list of diagnosis codes for confirmation by the user and software for prompting a user to submit procedure information and diagnosis information indicative of a procedure and a diagnosis, respectively, based on the listed procedure codes and diagnosis codes.

Optionally, the invention includes software executing on the computer for receiving a prompt to begin transmitting the procedure and diagnosis codes. The procedure or diagnosis information may be in the form of voice, text, or both.

In another aspect of the invention, the system for facilitating generation of a form includes a computer, software executing on the computer for receiving a search term inputted by a user, software executing on the computer for searching a database for a procedure based upon the search term, software executing on the computer for identifying all procedures based upon the search term, software executing on the computer for identifying a procedure code for each identified procedure, and software executing on the computer for listing each procedure code together with each identified procedure.

The system may include software executing on the computer for prompting a user to select a procedure code and select a corresponding procedure from the listed procedure codes and procedures and software for receiving a selected procedure code and a corresponding selected procedure from the listed procedure codes and procedures.

Similarly, the system may perform the same functions for diagnosis information as it does for procedure information, namely software executing on the computer for searching a database for a diagnosis based upon the search term, identifying all diagnoses based upon the search term, identifying a diagnosis code for each identified diagnosis, listing each diagnosis code together with each identified diagnosis, and receiving a selected diagnosis code and a corresponding selected diagnosis from the listed diagnosis codes and diagnoses.

Additionally, the system may also include software for requesting additional comments from a user, software for receiving the requested additional comments, and software for relating the received additional comments to the selected procedure code and selected diagnosis code.

In an aspect for generation of a claim form, a system is provided including a computer, software executing on the computer for displaying a form having a plurality of subheadings, software executing on the computer for automatically retrieving information from a storage medium and specific to the selected subheading, and software executing on the computer for automatically transmitting the retrieved information for confirmation by a user.

Optionally, the system may include software executing on the computer for attaching the retrieved information to the form proximate to the selected subheading, wherein the information is selected from the group consisting of a procedure code, a diagnosis code, additional comment, and combinations thereof.

In another aspect of the invention, system may be utilized to facilitate generation of a form by receiving voice and translating the voice into a text file for insertion into selected areas of the form. The system includes a computer, software executing on the computer for displaying a form having a plurality of subheadings, software executing on the computer for, when a subheading is selected, receiving voice information. The system also includes software executing on the computer for automatically translating the received voice information into text information and inserting the text information proximate to the selected subheading.

The system may further include software executing on the computer for receiving the voice information in real time. In some aspects, the system may include software for automatically inserting the text information into the form proximate to the selected subheading and transmitting the text information to a printable format without user intervention.

### BRIEF DESCRIPTION OF THE DRAWINGS

FIG. 1 depicts the system in accordance with the invention.

FIG. 2 more particularly depicts the step for entering a procedure shown in FIG. 1.

FIG. 3 more particularly depicts the step for entering a diagnosis shown in FIG. 1.

FIG. 4 depicts an example of a claim form that may be generated using the system shown in FIG. 1.

FIG. 5 depicts another aspect of the system of FIG. 1.

### DETAILED DESCRIPTION OF THE DRAWINGS

The invention relates to software for facilitating generation of claim forms. The generated claim forms may be submitted to and/or used by another party, such as an insurance entity. In one aspect, voice is used to input information via telephone so that the software may, with voice recognition technology, use the inputted information to generate or fill out part of the claim form.

However, voice and voice recognition software should not be a limitation to the invention. In another aspect, keyboard or keypad entry, such as a computer, personal digital assistant (known as PDA) like Palm™, or word processor, are used to input information. In further aspects, information is not needed to be spoken or typed in by a user but may be submitted, or inputted, by downloading from a storage medium, emailing, faxing, or other manner of submission, such as Internet downloads or connections, real time connections, or yi fi hook up.

Although various aspects of the invention are directed to varying ways of inputting information, the software for facilitating generation of the claim forms is not generally dependent upon the various ways of inputting the information and one version, or generation, of the software should be compatible with all manners of inputting information. In the below description of the figures, phone and voice are described. However, it is understood that any manner of input, as stated above, may be employed besides a phone or voice.

Likewise, although various hardware may be used in various aspects, such as telephone to computer connection using voice cards or computer to computer connection using storage mediums, the software for facilitating generation of the claim forms is not generally dependent upon the various hardware and one version, or generation, of the software should be compatible with all varying arrangements of hardware.

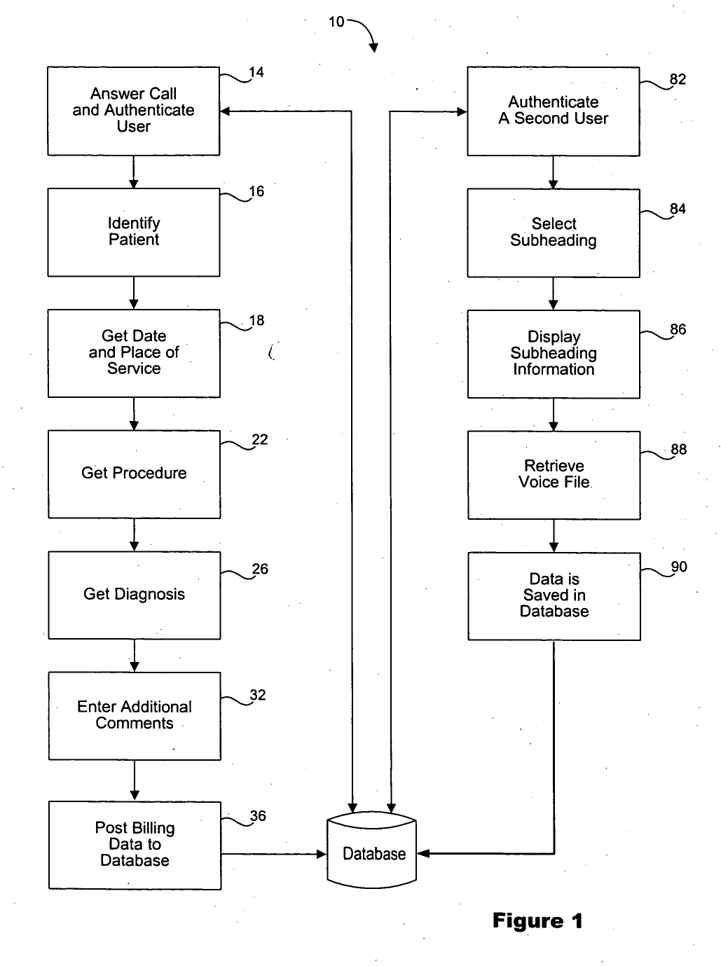

FIG. 1 depicts system 10, or software, for facilitating generation of claim forms in accordance with the invention. A user who wishes to generate a claim, such as a doctor or other medical personnel, with system 10 actuates system 10 by making a phone call. As shown, system 10 answers 14 the phone call and automatically prompts the user to authenticate himself/herself. Authentication is typically done by entering a user name and/or password via a touchtone telephone or, in the event voice recognition technology is used, speaking a username and password. In addition, dates of birth, social security number, or other personal information may be required by system 10 to authenticate the user or patient.

Upon identifying 16 the patient, system 10 prompts the user to enter 18 the date and place of service, prompts the user to enter 22 the procedure that was undertaken, and prompts the user to enter 26 the diagnosis of the patient. In response to each prompt for date, place of service, procedure, and diagnosis, the user may enter the information via voice or touch tone phone. If the information is entered via voice, the user simply speaks and software records the voice as a voice file for later retrieval by a second user, such as an assistant who has the duty of physically filling out the claim in hardcopy. It is envisioned that voice may be in free style form or boolean form.

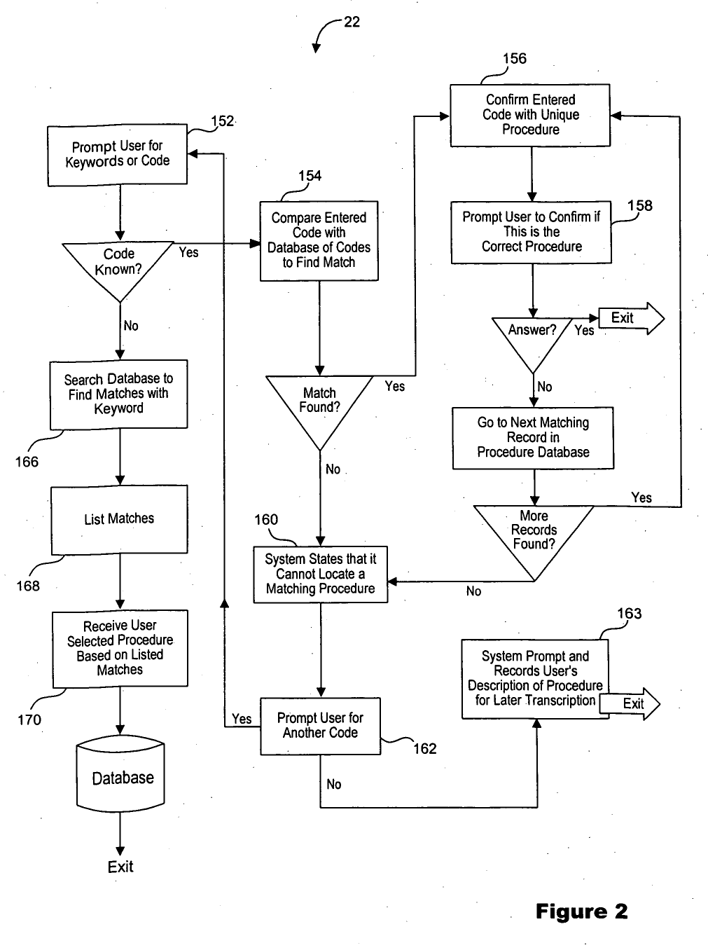

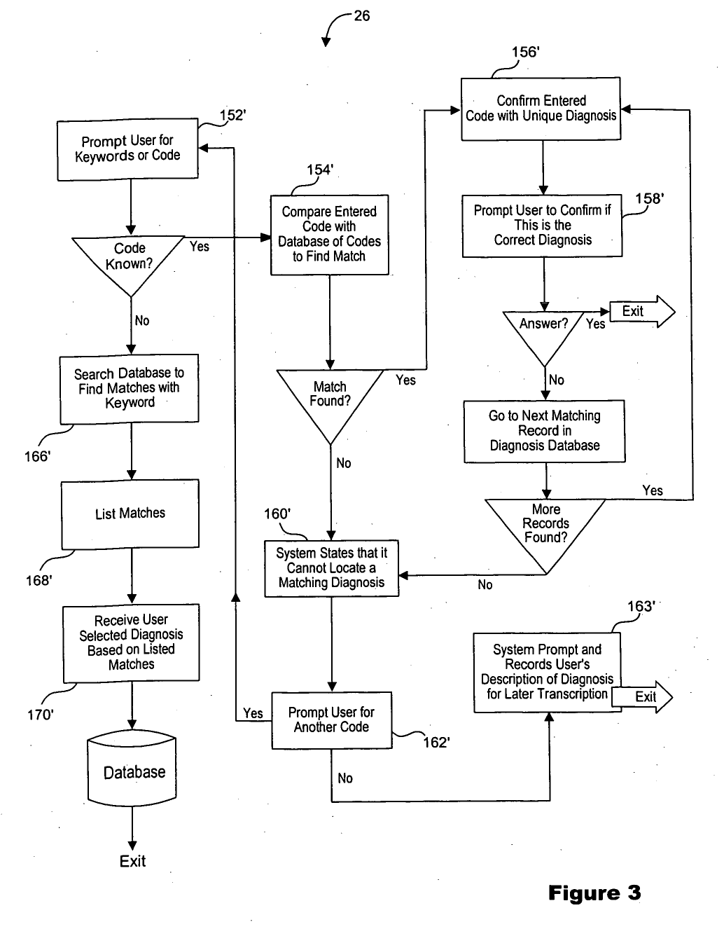

In the event the user is to enter the procedure and diagnosis via touch tone phone, the user would enter a numerical code that indicates a particular procedure or diagnosis, wherein different codes indicates different procedures or diagnoses. In the event the user does not know the numerical code that represents a particular procedure or diagnosis, the user may select a unique numerical code representing a particular procedure or diagnosis from a list of unique numerical codes. System 10 would prompt the user to make a choice as to whether or not the user wishes to enter the numerical code or choose the numerical code from a list. For the latter, whether for selecting a procedure or diagnosis, system 10 would, for example, state the code followed by the procedure and continue in this cycle until the user, upon hearing the desired code and procedure, enters the code by pushing the touch tone buttons of the phone. Selecting the procedure and diagnosis from a list of codes, each code uniquely representative of a particular procedure or code, are described in greater detail under FIGS. 2 and 3.

System 10 next prompts the user to optionally enter 32 additional comments. Such comments may supplement the procedure or diagnosis should the user optionally decide to do so. The user may enter 32 additional comments via voice or touch tone phone. In other aspects, additional comments are entered 32 via computer or submission by a storage medium. If entering 32 via voice, a voice file is recorded and stored on a database by software. In further aspects, if entering 32 via phone, and similar to entering the procedure and diagnosis, 22 and 26, the user may select the additional comment from a list of comments by entering the numerical code upon hearing the comment being read from a list of codes by system 10. Each numerical code from a plurality of codes represents a unique additional comment from a list of additional comments.

Upon optionally entering 32 additional comments, or bypassing this step by indicating a bypass via voice or touch tone phone, system 10 then prompts the user to save or post 36 the information to a database.

In some aspects, prior to posting 36 the information to be saved in the database, system 10 may prompt the user to optionally decide if he/she wishes to review all of the entered information, as a way of confirming the inputted information and all selections made are correct. The user may wish to listen to all of the information that was previously made for each prompt, namely the procedure, diagnosis, and additional comments for an identified patient. In other aspects, the user may only desire to confirm a portion of the information. In these aspects, or where the user wishes to bypass reviewing any of the information, system 10 allows the user to skip to the posting 36 step.

Although inputting information is described to be via voice or touch tone phones, it is understood that other manners for inserting the information is envisioned. For example, as mentioned above, computer keystrokes, personal devices, internet downloads, or any other way information may be submitted may be utilized in lieu of or in addition to voice or touch tone phones.

FIG. 1 is directed to system 10 being utilized by a user, such as medical personnel, where information was inputted into the database. Once saved in the database, a second user, who would be an assistant, would need to access the information stored on the database to generate a hard copy of and complete the claim form. The second user may also review the claim form to ensure all information is inputted correctly.

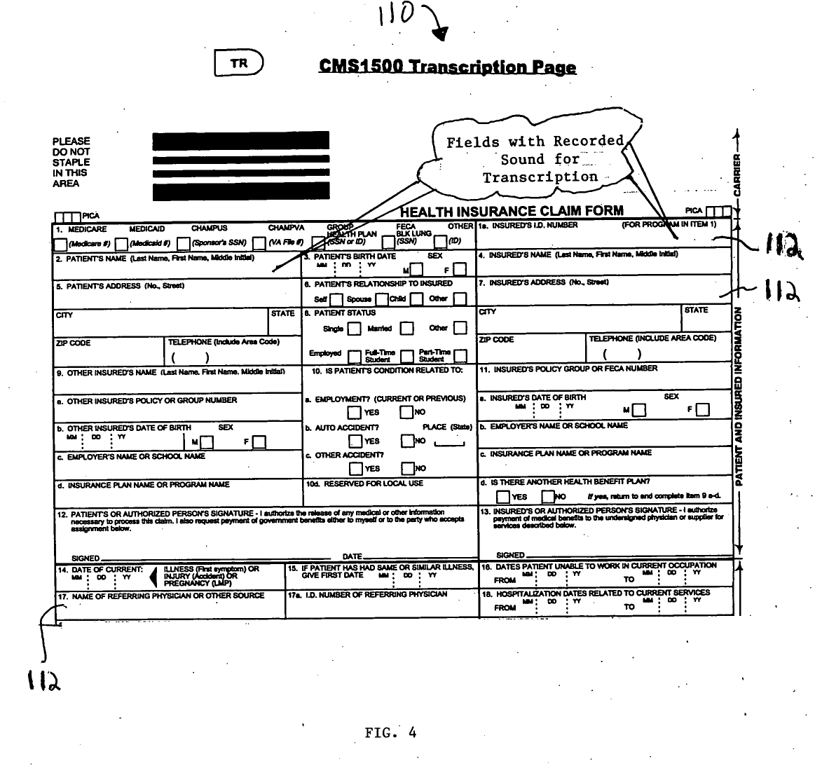

The second user would activate the software by inputting his/her username and password. System 10 authenticates 82 the second user and then automatically, or is prompted by the second user, displays an electronic image of the claim form on the second user's computer or word processor. FIG. 4 depicts an example of the claim form 110 the second user may see on the computer screen. For exemplary purposes, the CMS transcription page is shown but this should not be viewed as a limitation of the invention because any electronic image of anything that is to be filled out by a second user, whether a form or not, is envisioned by the invention. Also, although the second user may be described to be viewing form 110 on a computer screen, it is understood that any structure capable of displaying form 110 suffices, such as a word processor, PDA, remote microprocessor, and the like.

Each or every part of claim form 110 that may be filled out is defined to be subheading 112, where information to be inserted into subheading 112 is inputted by medical personnel users (the first users) and stored on database. For information that is successfully posted 36 to the database, the information may already be automatically inserted under the appropriate subheading 112 when claim form 110 is pulled up by the second user, in which case the second user need only review the information to be sure it is correct. The second user may do this by placing or clicking 84 the computer's mouse over subheading, which would prompt system 10 to retrieve and display 86 the information specific to the specific subheading 112 that was actuated. Once retrieved and displayed, the second user may review and/or copy the displayed information under subheading 112. In further aspects, where the user inputs information by speaking and where a voice file is recorded, system 10 retrieves the voice file specific to the selected subheading 112 and plays it back for the second user to hear. The second user may edit or insert information under the selected subheading 112 as the voice file is played. In some of these aspects, the voice file is automatically retrieved and played without user intervention upon subheading 112 being selected.

Each subheading 112 of the claim form is hypertexted, or capable of being actuated, by the second user. In one aspect, the second user need only place a cursor, mouse, pen, or a body part of the second user in the case of a touch screen over the subheading 112 and system 10 automatically and without user intervention retrieves the information posted 36 from the database that is related to the actuated, or selected, subheading 112. Upon retrieval, system 10 may also automatically and without user intervention transmit the retrieved information to the computer screen so that the second user may compare what is retrieved and transmitted, or displayed, with what is in subheading 112. The second user may perform any edits at any time to any subheading 112.

In another aspect, and without user intervention, upon subheading 112 being actuated, system 10 automatically retrieves the information posted 36 from the database that is related to the actuated, or selected, subheading 112 and inserts the retrieved information into subheading 112. This is helpful when subheading 112 is blank and where a voice file is saved in the database. It should be known that for any part of system 10 when the first user does not speak clearly into the phone or when information that is supposed to be inputted is not entered via touch tone phone, a voice file may be saved on the database. In certain aspects, a voice file is always saved as a backup to the inputted information.

In another aspect, and in the event information is not successfully posted 36 to the database or system 10 did not properly insert the information under the respective subheading 112, the second user may prompt system 10 to retrieve 88 a voice file. Voice files would typically be recorded when the medical personnel did not keystroke enter information but rather used voice to input the information shown in FIG. 1. After listening to the voice file, the second user may then insert the information in claim form 110 by typing in the information or by instructing software to translate the voice file to a text file and then insert the text information in form 110. After filling out claim form 110, the second user may save 90 the information to the database and/or print out claim form 110 for submission to another entity, such as an insurance entity. It is envisioned that form 110 may be printed out at any time by the second user and may further be sent to another entity by all known or novel methods, such as email, facsimile, and the like. Also, form 110 may be transmitted in digital, analog, electronic, or hardcopy format and may further be in conformance to certain guidelines, such as the Health Insurance Portability and Accountability Act (“HIPAA”).

FIG. 2 more particularly depicts the step for entering 22 procedural information. System first prompts 152 the user to enter the numerical code representing the medical procedure to be performed or that was performed on the patient, or enter a set of key words, either by voice or keystrokes from a keypad or computer, indicative of a procedure so system 10 may search for a numerical code unique to the procedure.

If the user knows and enters the code, system 10 compares 154 the entered code with a database of codes to find a match. This database of codes may be any standard set of codes adopted by medical personnel, such as the Current Procedural Technology (“CPT® Codes”) and/or HIPAA. Once a match is found, system 10 confirms 156 the entered code with the particular procedure unique to the code by displaying or playing back the entered code and unique procedure and then prompts 158 the user to confirm, or indicate, that the match provided by system 10 is correct. Once the user confirms the match is correct, system moves to the step for prompting 26 the user for the numerical code representing the diagnosis.

If the entered code is not matched with any of the codes in the database, which will be described hereinafter as the CPT® Codes (but understood that any codes besides the CPT® Codes may be adopted, such as hospital codes), or if the entered code is not confirmed to be correct by the user when system prompts 158 the user to confirm the match is correct, then system 10 informs 160 the user that the entered code is not correct and asks 162 the user if he/she wishes to enter another code. If the user indicates he/she wishes to enter another code, system begins again with a prompt 152 for key words or a numerical code. If the user indicates he/she does not wish to enter another code, system 10 prompts the user to record 163 a voice file for later transcription moves to the entering 26 diagnosis step.

If the user does not know the numerical code, he/she can enter a set of key words. Upon entering the key words, each key word is repeated back to the user for confirmation. Upon confirmation, system 10, or software, would prompt 166 system 10 to search the CPT® Codes database to match each of the confirmed key words with words in the CPT® Codes database. If numerous records are found (meaning numerous matches were found between what is stored on the CPT® Codes database and all key words), then system 10 would alert the user to the numerous records found and request the user to provide further keywords in an effort to narrow the search and reduce the number of records found. If a sufficiently small number of records are found, the procedures would be listed 168 by software along with their unique numerical code. Upon hearing the desired code and procedure, the user may speak or otherwise indicate 170 the desired code, such as by touch tone phone. Once the code is selected and inputted by the user, the code is saved onto the database and system 10 automatically moves to the next step of entering 26 a diagnosis. Any arbitrary quantity of records may determine whether or not the matched records are numerous or sufficiently small. For example, system 10 may be programmed to list all procedures having 10 records or less.

If the key words entered do not match any of the key words found in the CPT® Codes database, system would inform 160 the user of such event, and prompt the user to reenter key words or record a voice file for storage and later retrieval. Optionally, if key words or codes are inputted and not found, system 10 permits the user to try again. In some aspects, the user is limited as to the number of tries and, upon reaching this limit, software automatically prompts the user to speak the key words or procedure and system 10 records a voice file for later retrieval.

FIG. 3 more particularly depicts the step for entering 26 a diagnosis. As shown in FIG. 3, the steps for entering 26 a diagnosis, including keywords, numerical codes, and code databases, have the same limitations as those of FIG. 2. The difference between the steps for entering a procedure or steps for entering a diagnosis lies in the information, codes, databases, or numerical codes, but the steps or methods for inputting a procedure or diagnosis code are similar. Codes utilized in FIG. 3 include those provided or sanction by the World Health Organization, American Medical Association, HIPPA, and/or any set of codes adopted by medical personnel.

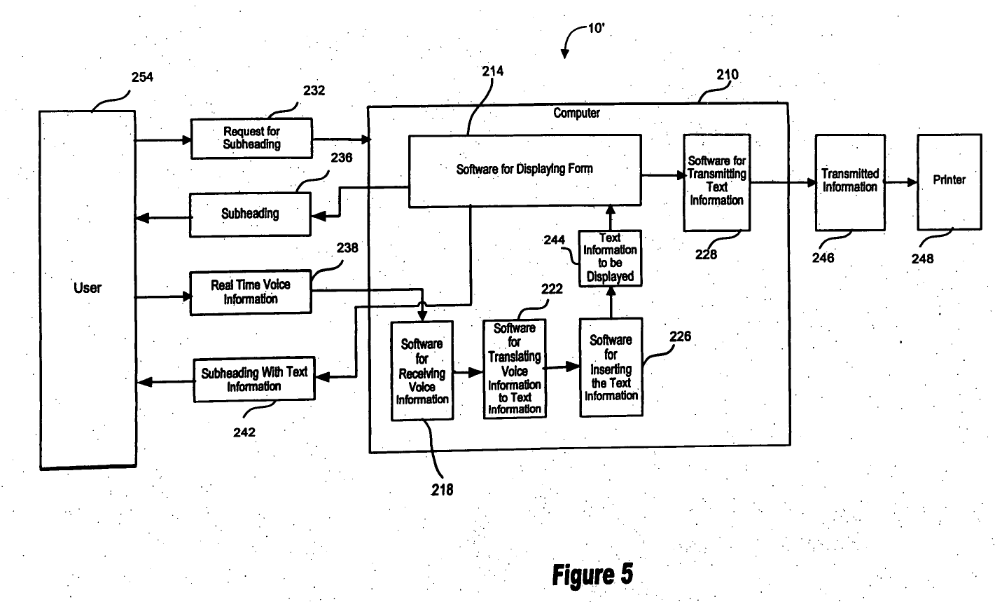

FIG. 5 depicts another aspect of the invention where a form is filled out in real time without typing or writing, and where voice information is automatically translated into written information and automatically inserted proximate to user selected areas of the form that are to be filled out, thereby facilitating generation and completion of a form.

Law enforcement officials may utilize system 10′ for filling out tickets, such as tickets for traffic, parking, speeding, and/or other infractions. Law enforcement officials may also find system 10′ beneficial in that system 10′ permits an officer, who has pulled over a driver, to fill out a ticket while reducing the amount of time the officer takes his/her eyes off the driver as compared with traditional manners for filling out tickets, which often requires the officer to hand write the ticket and where writing tickets by hand increases the instances the officer looks away from the driver toward the ticket he/she is filling out.

As shown in FIG. 5, system 10′ includes computer 210, software 214 executing on the computer for displaying a form having a plurality of subheadings. User 254 activates computer 210 using all known or novel manners, including being authenticated or identified as an authorized user. User 254 transmits request 232 for a subheading to be filled out. Request 232 includes clicking on the selected subheading to actuate software 214 for displaying form to send user 254 an indication that the selected subheading 236 is available for editing or being filled out. Subheading 236 includes all the limitations as described above for subheading 112.

Upon receiving subheading 236, or an indication subheading 236 is available for editing, user 254 speaks the words, or sends voice information 238, to be converted into written text and inserted proximate to subheading 236. Software 218 executing on the computer for receiving voice information from user 254 receives voice information 238. Software 222 for translating voice information to text information converts voice information 238 to a text file, or text information 244. Software 226 for inserting the text information next inserts text information 244 into the form proximate to the user-selected subheading 236. Software 214 for displaying the form then displays a form modified to include text information 244 inserted in the user determined location proximate to subheading 236. In the event further modification is desired by user 254, user 254 requests 232 subheading 232 and software 214 then transmits an indication that the revised subheading 242, which has been modified to include text information 244, is available for further editing.

System 10′ further includes software 228 for transmitting text information, whether to be printed or electronically sent to another entity, such as police headquarters or a courthouse. If the form is desired to be printed, software 228 for transmitting text information transmits text information 244 to printer 248 for printing.

In some aspects of system 10′, the voice information may be in real time. Moreover, software 228 for transmitting text information may automatically transmit text information 244 to a printable format without user intervention. Further, software 226 for inserting the text information may automatically insert text information 244 without user intervention.

Although the description under FIG. 5 is described to be related to law enforcement uses, this is not a limitation of the invention as system 10′ may be applicable to generating claim form 110 of FIG. 4, insurance forms, job application forms, or any form that may be filled out in electronic form on computer 210.

1. A system for facilitating generation of a medical claim form, comprising:
a computer;
software executing on the computer for receiving a search term inputted by a user;
software executing on the computer for searching a database of stored medical insurance acceptable procedures and corresponding stored medical insurance acceptable procedure codes for a procedure based upon the search term;
software executing on the computer for identifying all procedures based upon the search term;
software executing on the computer for identifying a corresponding procedure code for each identified procedure; and
software executing on the computer for listing each identified procedure together with each corresponding procedure code.

2. The system according to claim 1, further comprising software executing on the computer for receiving a selected procedure code and a corresponding selected procedure from the listed procedure codes and procedures.

3. The system according to claim 2, further comprising software executing on the computer for prompting a user to select a procedure code and select a corresponding procedure from the listed procedure codes and procedures.

4. The system according to claim 1, further comprising software executing on the computer for
searching a database for a diagnosis based upon the search term;
identifying all diagnoses based upon the search term;
identifying a diagnosis code for each identified diagnosis; and
listing each diagnosis code together with each identified diagnosis.

5. The system according to claim 4, further comprising software executing on the computer for receiving a selected diagnosis code and a corresponding selected diagnosis from the listed diagnosis codes and diagnoses.

6. The system according to claim 5, further comprising software executing on the computer for requesting additional comments from a user.

7. The system according to claim 6, further comprising software executing on the computer for receiving the requested additional comments.

8. The system according to claim 7, further comprising software executing on the computer for relating the received additional comments to the selected procedure code and selected diagnosis code.

9. A system for facilitating generation of a medical claim form, comprising:
a computer;
software executing on the computer for receiving audio procedure information indicative of a procedure performed on a patient;
software executing on the computer for receiving audio diagnosis information indicative of a diagnosis of a condition of the patient;
software executing on the computer for retrieving a procedure code based upon the received audio procedure information, the procedure code is one of a plurality of medical insurance acceptable procedure codes stored on a database;
software executing on the computer for retrieving a diagnosis code based upon the received audio diagnosis information, the diagnosis code is one of a plurality of medical insurance acceptable diagnosis codes stored on a database; and
software executing on the computer for transmitting the procedure code and the diagnosis code for use in generating a claim form.

10. The system according to claim 9, further comprising software executing on the computer for authenticating a user based on submitted user identification information.

11. The system according to claim 9, further comprising software executing on the computer for prompting a user to submit procedure and diagnosis information.

12. The system according to claim 9, further comprising software executing on the computer for requesting additional comments to be submitted by a user.

13. The system according to claim 12, further comprising software executing on the computer for receiving the requested additional comments.

14. The system according to claim 13, further comprising software executing on the computer for relating the requested additional comments to the procedure code and diagnosis code.

15. The system according to claim 14, further comprising software executing on the computer for listing a list of procedure codes along with a corresponding list of diagnosis codes for confirmation by the user.

16. The system according to claim 15, further comprising software executing on the computer for prompting a user to submit procedure information and diagnosis information indicative of a procedure and a diagnosis, respectively, based on the listed procedure codes and diagnosis codes.

17. The system according to claim 9, further comprising software executing on the computer for receiving a prompt to begin transmitting the procedure and diagnosis codes.

18. The system according to claim 9, wherein procedure information or diagnosis information is a voice file.

19. The system according to claim 9, wherein procedure information or diagnosis information is a text file.

20. A system for facilitating generation of a medical claim form, comprising:
a computer;
software executing on the computer for displaying a form having a plurality of subheadings;
software executing on the computer for, when a subheading is selected, automatically retrieving information from a storage medium and specific to the selected subheading; and
software executing on the computer for automatically transmitting the retrieved information for confirmation by a user.

21. The system according to claim 20, further comprising software executing on the computer for attaching the retrieved information to the form proximate to the selected subheading.

22. The system according to claim 20, wherein the information is selected from the group consisting of a procedure code, a diagnosis code, additional comment, and combinations thereof.

23. The system according to claim 20, wherein the information is a voice file or text file.

24. A system for facilitating generation of a ticket, comprising:
a computer;
software executing on the computer for displaying the ticket having a plurality of subheadings;
software executing on the computer for, when a subheading is selected, receiving voice information;
software executing on the computer for automatically translating the received voice information to text information and inserting the text information proximate to the selected subheading of the ticket; and
software executing on the computer for transmitting the text information.

25. The system according to claim 24, further comprising software executing on the computer for receiving voice information in real time.

26. The system according to claim 24, further comprising software executing on the computer for automatically transmitting the text information to a printable format without user intervention.

27. The system according to claim 24, further comprising software executing on the computer for automatically inserting the text information proximate to the selected subheading without user intervention.
